(19) United States
(12) Patent Application Publication
(10) Pub. No.: US 2005/0191958 A1
(43) Pub. Date: Sep. 1, 2005

(54) Multi-level priority communications and broadcast scanning receiver

(76) Inventor: Rodney W. Hoskins, New Richmond, OH (US)

Correspondence Address: R. WINSTON SLATER, 109 N. MAIN STREET, ALGONQUIN, IL, 60102, US

(21) Appl. No.: 10/789,658

(22) Filed: Feb. 27, 2004

(51) Int. Cl. H04Q 7/20; H04B 7/00

(52) U.S. Cl. 455/3.01; 455/3.06

(57) ABSTRACT

A communications or broadcast and communications receiver combination including microprocessor controlled synthesized communications and broadcast receivers, a keypad for entering multiple frequencies into corresponding memory addresses, said frequencies defining channel(s) to which the receiver is currently tuned, frequency limits for free scanning between such limits, channels of interest to be scanned; and, importantly, two or more priority channels, said channels being assigned at least two differing priorities and microprocessor control to periodically check each priority channel and to promptly tune the receiver to any channel possessing a priority and, in turn, to the channel possessing the highest priority where more than one priority channel is active at any given time.

### BACKGROUND OF THE INVENTION

The present invention relates generally to synthesized scanning receivers and, generally, to dual-service scanning receivers having two or more ‘bands’—each band intended and specifically dedicated for the receipt of signals in one of the various commercial broadcast services (e.g. AM or FM broadcast) or one of the two-way communications services. Communications services as used herein are intended to broadly include the panorama of public services (e.g. police and fire), business, telephone, and personal services (e.g. ham, CB and other personal communications allocations) as well as frequency bands used for specialty applications such as aviation navigation and air-traffic-control. More specifically, the present multi-band scanning receiver includes multiple priority channel monitoring with ranking, that is, where priority channels may be nested or layered whereby the relative priority of each may be defined, in turn, whereby at least one priority channel is defined as being the “most important” and being given priority over all other channels, including other priority channels. While the nested priority system of the present invention is principally contemplated for use in conjunction with dual-service receivers, it will be understood that the staggered priority disclosed herein is applicable to single-service receivers as well to enable the listener to monitor plural priority channels according to a user-defined priority hierarchy.

It will be appreciated that the broadcast and communications services differ in one important feature germane to the present invention; namely, that broadcast transmitters remain ‘on-the-air’ essentially continuously while communications transmissions are characterized by generally short duration bursts of a random, unpredictable nature. Scanning receivers are known for both of these diverse services. However, scanning of broadcast frequencies is generally intended for the limited purpose of sampling each broadcast station—typically for sufficient time to enable the listener to identify the nature of the commercial broadcast being received—thereafter the receiver continues its scan repeatedly stopping for short durations on successive occupied broadcast frequencies as described. By contrast, the purpose and function of a communications receiver scanner is, first, to find and identify channels that contain such sporadic communications and, when found, to allow the listener to monitor that channel for as long as the channel remains in use.

This continuous-intermittent transmission dichotomy is even more pertinent to scanners having priority channel capability. While, as described above, scanning receivers are known for both the commercial and communications services, the concept of priority—defined as the process of identifying the presence of a signal or transmission on a defined priority frequency, then, immediately, switching the receiver to that frequency for monitoring—is meaningless in the broadcast service where such transmitters remain “on-the-air” continuously. There is no practical purpose in identifying the presence of a commercial transmission as it is known a priori that the signal is there.

The present receiver, as noted, is advantageously designed to integrate broadcast and communications functions, to permit the scanning of either service type combined with communications priority channel(s)—again, where communications channel priorities can be layered according to the respective importance (priority) of each.

The present receiver finds particular application in specialized environments where the user desires to listen to, for example, broadcast coverage of an event while simultaneously desiring to monitor the intermittent communications traffic often associated with that event. It is therefore a principal feature the present invention to permit the substantially instantaneous switching between broadcast reception and communications reception whenever the communications channel becomes active. However, it will also be noted that it is not infrequently the desire of the listener to monitor a first communications channel in the expectation that the receiver will jump to another, but priority or higher priority, communications channel when such channel becomes active. It must again be emphasized consistent with the invention herein described that the first communications channel may, itself, be a priority channel—the receiver having been earlier switched to this first priority channel by reason of its “activity”—thereafter being forced to another communications channel of “higher” priority.

Mixed service priority scanning receivers are not unknown to the art. One popular implementation has been in the automotive context where two-way Citizens Band (CB) communications receivers have been combined or integrated with conventional AM/FM car broadcast receivers whereby the detection of a CB “transmission”, generally on a preset channel, preempts the broadcast reception—replacing the later with the former. Rogers, U.S. Pat. No. 4,105,974, is representative of such a combination, literally describing an after-marker ‘control circuit’ connected in the speaker output line of a standard automobile AM/FM to effect the desired substitution of signals. Calman, U.S. Pat. No. 4,027,249 is nearly identical to Rogers '974 functionally (differing only in the retention of the CB receiver speaker for the audio output therefrom). See also Tudor, U.S. Pat. No. 4,164,709 as teaching similar art; Kostanty, U.S. Pat. No. 4,524,461 as teaching the AM/FM/CB radio interface for motorcycles where, literally, the CB radio “pulls the power” from the AM/FM radio during periods of CB radio activity; and Hadley, U.S. Pat. No. 5,243,640 as teaching the disabling of broadcast during periods of two-way cell phone usage.

Goncharoff, U.S. Pat. No. 4,287,599, (automotive AM receiver interrupted by CB radio); Beard, U.S. Pat. No. 6,055,419 (a receiver, only, in which AM/FM broadcasts are interrupted by communications transmission) advanced the art one step further in teaching the scanning of a plurality of priority channels; and, a prior receiver marketed by the present assignee, the SP200 (broadcast program interrupted by air-traffic transmission). In these latter disclosures the art teaches the operative interconnection and interaction between scanning and priority.

The present mixed-service scanning apparatus principally addresses the “monitoring” function and, preferably, in a portable hand-held package rendering it suitable for use by attendees at public events (e.g. by race fans, see Beard '419). Indeed, the present receiver was specifically motivated and developed to address the public airshow environment and, to that end, integrates air-traffic-control (ATC) communications frequencies with its AM/FM broadcast reception capability. Again, it should be understood that the teachings herein are not limited to any particular combination broadcast and communications “band”. To the contrary, in a the broader definition of the present invention, a plurality of communications bands may be incorporated whereby a single receiver would be suitable for attendees at a wide variety, if not all, public events where broadcast and/or communications systems are utilized in connection with such event.

The above discussion suggests that certain public events incorporate both broadcast and communications services—typically, the broadcast being made available for the “lay public” to describe, both for attendees and the remaining listening audience, the on-going events, while the communications channels are utilized by production coordinators or performers for coordination of their specialized participations. One well-known example of the foregoing is the summertime Chicago Air and Water Show where local broadcast stations cover the two-day event, essentially full and real time, but only occasionally incorporate into their public broadcasts, the air-traffic-control and air-to-air communications—which communications are, frankly, of more than casual interest even to the non-pilot/boater lay attendee.

While the present invention finds particular utility in public exhibitions and shows of this character (again, where dual broadcast/communications services are employed), the receiver described herein is intended and suited for a variety of less-integrated situations where, for example, the user simply wants to listen to a commercial broadcast program (or other non-broadcast channel) while monitoring the activity on one or more otherwise unrelated communications channels.

Further by way of generalization of the present invention, it will be appreciated that the disclosed multi-level scanning/priority receiver may be repackaged in a nonportable format (e.g. as a table radio), or combined with a full two-way communications transceiver.

In one implementation of the present invention, multi-level priority scanning is defined by a plurality of communications channels, each programmed by the user into “memory”, in which the respective priorities between programmed channels is determined by the respective locations of the channels in the memory registers, or memory stack. There are no technical limitations on the number of user programmable memory channels, nor the number of differing ‘priority-levels’, there may be. While one preferred embodiment of the present receiver defines just five programmable communications channels at two levels of priority—this comparatively limited implementation was chosen merely to simplify the human “user” interface and should not be taken in any way to limit the scope of the disclosed technology.

The number of priority levels and channels, however, may impact the rate and pattern of priority channel scanning. In general, communications priority channels may be scanned “in the background” when the receiver is ‘parked’ or listening to a broadcast station. This is possible by reason that in the preferred arrangement, separate RF, IF, and synthesizer systems are employed for each of the broadcast and communications ‘bands’—thus, priority channels can be scanned or monitored for activity simultaneously while the user is listening to a commercial broadcast.

However, when the receiver is ‘listening’ to a first communications channel—either due to user input (i.e. channel selected by user) or due to receiver ‘priority’ switching whereby the receiver is forced to the channel by reason that it is, itself, an active priority channel—the communications receiver is effectively ‘occupied’ and therefore cannot check for priority on the other, higher priority channels, without momentarily interrupting reception of this ‘first’ channel. While these interruptions are of comparatively short duration (generally measured in milliseconds corresponding to the sum of the phase-locked-loop synthesizer settling and squelch detect times), too frequent priority sampling will degrade satisfactory reception of the communications channel currently being ‘listened to’.

In view of the foregoing, it will be noted that layered or nested priorities may be distinguished not merely by which channel (priority level) will be heard when multiple priority channels are active simultaneously, but by the frequency, or repetition rate, by which each priority level channel is scanned. In a preferred embodiment of the present invention, the highest priority channel is ‘sampled’ for activity more frequently than lesser priority channel. More specifically, in the five priority channel, two priority level embodiment described herein, the highest priority channel is scanned once each second while the second tier of priority channels is sampled/scanned at half this rate.

It is therefore an object of the present invention to provide a scanning receiver or transceiver having multiple priority channels. It is a further object that these priority channels shall define at least two levels of priority whereby a signal detected on any of such priority channels shall interrupt, preempt, and replace a signal then-being received on a non-priority channel and whereby a signal detected on the higher or highest priority channel will similarly interrupt and replace a signal being received on a lesser priority channel as well as a non-priority channel. It is therefore an object of this invention that there shall be nested priorities where, in turn, detection of signals on successively higher priority channels, replace those at all lower priority levels.

It is yet another object of the present receiver that priority channels be defined on, or within, one or more communications bands generally characterized by the intermittent presence of signals on each of the priority channels. It will be understood that the non-priority channels may be communications channels or, in another preferred embodiment of the present invention, the receiver shall contain one or more broadcast bands whereby the user may listen to a commercial broadcast—such broadcast defining a non-priority channel. It is a further object that when listening to such a commercial broadcast, the present receiver shall be capable of monitoring activity on multiple priority channels, such channels defining more than one level or layer or priority within a nested priority hierarchy.

It is yet another object of the present invention that the receiver be adapted for use by attendees of public events where broadcast coverage of the event is provided and where there is the simultaneous, although intermittent, use of communication channels by those performing or otherwise involved in the event production. This object, more specifically, is to allow the user to efficaciously listen to most of the on-going event broadcast while being able to monitor by switching, substantially instantaneously, to the various priority communications channels that often bear interesting collateral traffic related thereto.

Various other objects and advantages of the invention will hereinafter become more fully apparent from the following description of the embodiments and the drawings wherein:

### BRIEF DESCRIPTION OF THE DRAWINGS

FIG. 1 is a front elevation view of the multi-level priority scanning receiver of the present invention; and,

FIG. 2 is block diagram of one embodiment of the multi-level priority scanning receiver of the present invention including substantially independent communications and broadcast receivers.

### DESCRIPTION OF THE PREFERRED EMBODIMENT

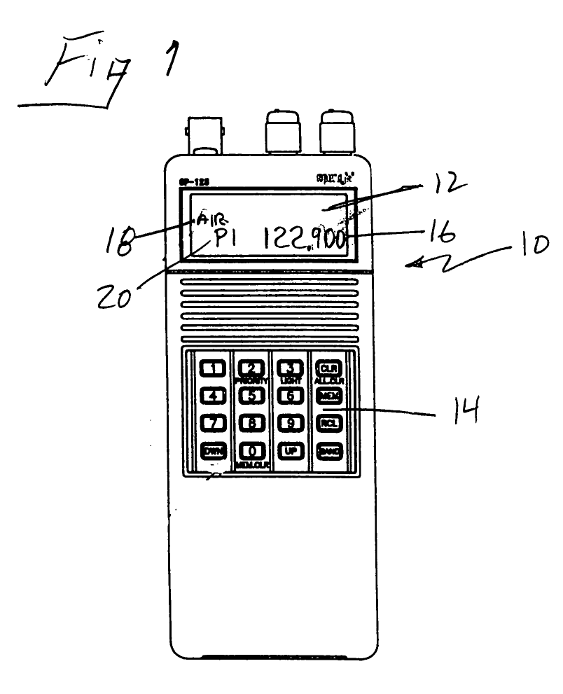

FIG. 1 illustrates a preferred, yet typical, receiver 10 of the present invention. While receiver 10, as shown, is battery operated and portable, fixed or table receivers and transceivers are also contemplated herein.

Receiver 10 includes an LCD display window 12 and a push-button programming and data entry keypad 14. Display window 12 principally serves as a ‘read-out’ of the frequency 16 currently being scanned or listened-to or, in the case of data entry, as a visual register confirming the frequency data as it is entered. Also shown on this display is the “band” to which the receiver is currently tuned (illustrated in FIG. 1 as the AIR band 18) and an indication whether the displayed “frequency” is a memory channel and, if so, which one. Priority channel one is show as “P1” at 20.

In this preferred arrangement receiver 10 includes two commercial broadcast bands, commonly known as AM and FM and one ‘aircraft’ communications band comprising the range of frequencies between 108 and 143 MHz. More specifically, this latter range of frequencies includes listen-only navigation/information frequencies at the lower end of the range between 108 and 118 MHz and two-way air-traffic-control and other informational communications channels above 118 MHz. Some air-traffic-control channels include those used by pilots to obtain weather ‘briefings’ or updates while airborne as well as a host of other aviation-related communications functions. Thus, while we often refer to “communications” and “two-way” radio synonymously, it will be understood that certain of the communications bands provide navigation and other one-way informational traffic (e.g. VHF public weatherband stations) in addition to the more conventional two-way function.

Both the broadcast AM/FM bands and the aircraft “AIR” band may be scanned. As noted in the background section of the present disclosure, however, scanning of broadcast is generally limited to identifying the presence of ‘stations’ in the listener's geographic area or, by using a ‘scan-and-release’ technology (whereby the receiver stops for a preset short duration on all active broadcast stations), users can search for stations of a particular program genre.

Scanning of the intermittently ‘occupied’ aviation communications channels is a principal function of the present receiver and is considered particularly useful in identifying aviation channels used in the area. However, of more significance to the present invention is the ability to scan one or more preset channels programmed into memory. Receiver 10 contains five memory channels that can be scanned. These channels are programmed through push-button entry at keypad 14.

It is important that receiver 10 displays the ‘location’ of each preset/programmed channel within the memory stack by reason that this location determines the corresponding priority of that channel. Channels are designated as P1 through P5 with P1 being given the highest priority. In the present embodiment the remaining memory channels, P2 thru P5, are all assigned equal, but lower, priority. It will of course be appreciated that more priority channels could be employed and, importantly, that these lesser priority channels could, themselves, be assigned differing priorities thereby creating a channel ‘hierarchy-of-importance’. For example, P5 could be assigned the least priority having, in effect, priority over broadcast stations or non-priority communications channels only. P4, while having this same priority as P5, would, additionally, have priority over preset memory channel P5. Similarly, progressively higher priorities could be assigned to, in turn, P3, P2 and finally, P1. The present dual-level priority system was chosen as a compromise between receiver capability, flexibility and ease-of-use. “Priority” is a subset of the more general concept of ‘scanning’. Priority does not require the receiver to scan, per se; rather, priority ‘checks’ or ‘samples’ the limited number of priority channels for activity. Scanning connotes the process whereby the receiver progressively moves from one channel to another—looking for an occupied channel. While the five priority channels may be scanned in this manner, the layered, multilevel priority of the present invention is particularly suited for user ‘listening’ to one of the AM/FM broadcast channels—channels which, as noted, are characterized by the continuous presence of the broadcast signal—while keeping an effective listening watch on one or more of the only-occasionally occupied ‘priority’ communications channels. It is in this mode that the user would be able to listen to a commercial account of a public event—on a more-or-less continuous, on-going basis—while simultaneously maintaining a listening watch on associated communications channels that, when active, would temporarily interrupt the commercial broadcast but, in view of the comparatively short duration of such interruptions and the presumed ‘significance’ thereof, the listener gladly accepts such interruption.

It is desired that the ‘sampling’ of the priority channels shall occur on a frequent basis in order to achieve the appearance of substantially instantaneous switching from the broadcast to the priority channel when activity is detected on the latter. The repetition rate is selected as fast as practical taking into account known synthesizer ‘settling’ and squelch detection times and the ‘distraction’ or apparent noise that results from too frequent sampling of priority, or higher priority, channels (while listening to a first communications channel). In this regard, the preferred embodiment incorporates essentially independent broadcast and communications receivers whereby the repeated and frequent sampling of priority channels may take place in the ‘background’ without causing any interruptions to, or ‘holes’ in, the reception of a broadcast signal. In contrast, priority sampling necessarily interrupts reception of another communications channel during those short, but periodic, intervals where the communications receiver is switched to, and samples, each higher priority channel. In the present receiver, sampling of the highest priority channel occurs once each second. Lesser priority channels may be sampled less often, for example, 2 seconds between samples. It will be appreciated, therefore, that in one arrangement of the present invention, the sampling rate of the priority channels is scaled whereby the highest priority channels are sampled more frequently than those of lower priority.

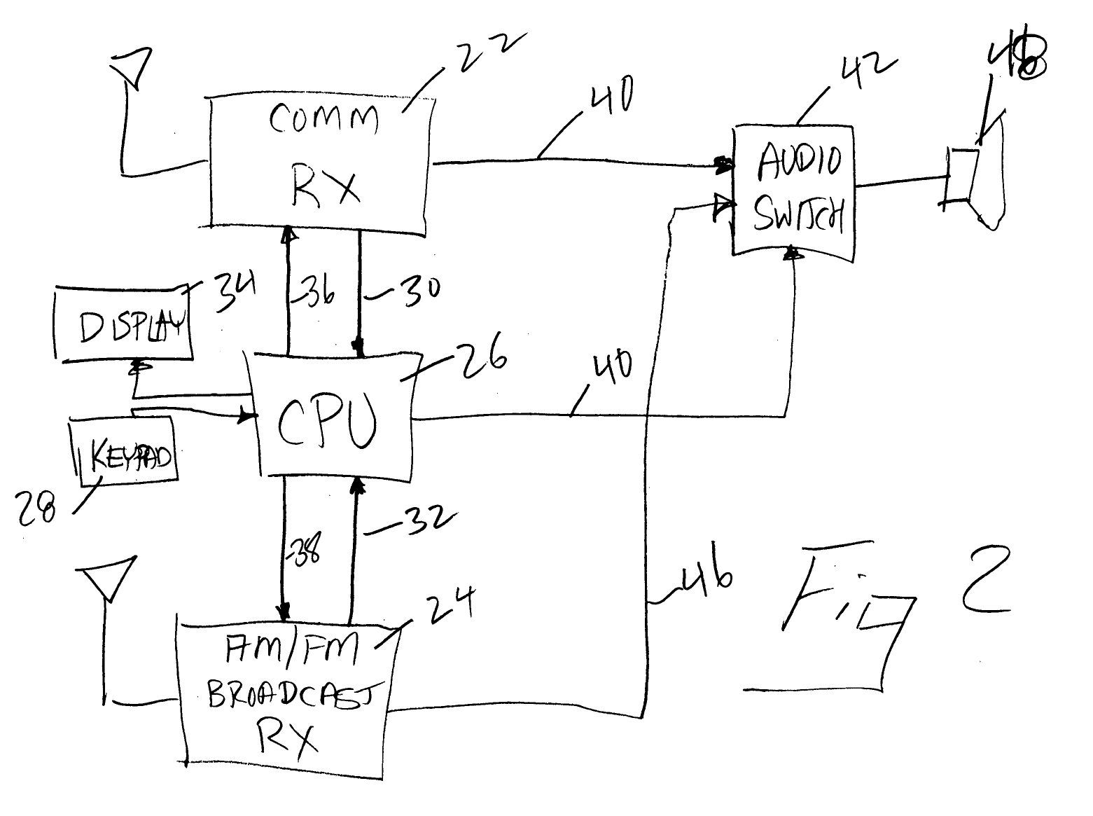

FIG. 2 illustrates the basic components of the present receiver including substantially independent communications and am/fm broadcast receivers 22 and 24, respectively. Each of these independent receivers includes a phase-locked-loop frequency synthesizer of conventional design, the control thereof, i.e. the frequency to which these receivers are set to “listen”, being set by a microprocessor 26 in response to user keypad 28 programming, squelch ‘detect’ outputs 30 and 32 and predetermined scanning and/or sampling algorithms described above.

User keypad 28 inputs include band selection (e.g. AM, FM or “AIR”); beginning and ending frequencies for ‘free scanning’ (i.e. where the receiver scans all available channels in numeric up/down frequency order between two ‘end’ or limit frequencies); memory channel frequency set-up (i.e. these are the priority channels which are entered as noted into designated locations, P1 thru P5, according to the relative priority desired therebetween); as well as a number of other routine administrative programming function, e.g. clear memory. Display 34 is provided to show data/frequency information during keypad entry (to facilitate errorless programming) as well as to display the frequency to which the receiver is currently tuned during general listening, scanning, and priority channel activity periods. Band, priority channel and priority level indications are also provided to help the user interpret what is being ‘heard’ on a real-time basis.

CPU 26 performs the scanning, priority checking, and manual user frequency selection functions and outputs appropriate frequency commands on data lines 36, 38 to the respective comm and broadcast receivers. Each receiver 22, 24 includes an AGC or squelch circuit of conventional design that, respectively, provides a ‘signal present’ indication on detect outputs 30, 32. Action of CPU 26 in response to these detect outputs is a function of which detect output is active and the corresponding priority of the channel being detected as more fully set forth below.

AM/FM broadcast receiver 24 scanning, as discussed above, is generally limited to determining which broadcast frequencies are active in a given region and/or user searches for particular program formats. In this regard, the CPU 26 response to a ‘signal present’ indication on detect output 32 is to momentarily halt the scanning of sequential broadcast frequencies (on data line 38) to permit the user to listen to the program material on the detected frequency. This ‘pause’ is generally of short duration, typically from 1 to 10 seconds. Thereafter, CPU 26 continues is scan until the next occupied broadcast channel is detected (i.e. another ‘signal present’ on detect output 32) where the process is repeated and repeated until the user terminates scanning through an appropriate keypad 28 input or until activity on a priority channel interrupts broadcast listening.

Turning to the comm receiver 22, operation of the receiver frequency selection data line 36 and the ‘signal present’ detect output 30 is substantially as described above in connection with broadcast data line 38 and detect output 32 particularly in connection with the sequential scanning of comm channels. A significant difference, however, occurs in connection with comm priority channel samping/scanning.

More specifically, without regard to whether the user is listening to a broadcast transmission (from receiver 24) or a non-priority comm channel (from receiver 22), CPU 26 commands the comm receiver 22 to periodically sample each of the programmed priority channels to ascertain whether any such channel is active. As previously described, higher priority channels may be scanned/sampled at a higher repetition rate than lower priority channels commensurate with the importance placed on such high priority activity.

Priority channel sampling is controlled over the same data line 36 and the presence of a priority signal is returned to CPU 26 over the same detect output 30 that governs normal comm receiver free scanning operations. It will be appreciated that priority ‘sampling’ necessarily interrupts on-going listening should the user be listening to another comm channel of either no priority or of a priority lesser than the one being sampled. (CPU 26 preferably terminates all scanning and sampling of lower or no priority channels when the receiver is listening to an active higher priority channel). In order that these samples not become distracting to the listener, the audio output 40 from receiver 22 is gated “off” by audio control switch 42, which switch is, in turn, controlled directly by CPU 26 on audio switch control line 44. Operation of audio switch 42 will be described in more detail below. For the present, it is sufficient to note that switch 42 passes either the broadcast receiver audio out 46, the comm receiver out 40 to the listener's speaker or headphones 48 or, as just described, all audio may be blocked during periods of priority channel sampling.

When a priority channel is detected (i.e. ‘signal present’ on detect output 30 when receiver 22 is tuned by CPU 26 via data line 36), such priority frequency is maintained on data line 36 (except as described below) until detect output 30 indicates the priority channel has returned to inactive status. At this moment, CPU 26 returns receiver 10 to the mode/condition it was in immediately prior to priority signal detection.

In this regard, if the user had been listening to another comm frequency, or was free scanning comm channels, comm receiver 22 would be returned to this frequency or scanning mode. Similarly, if the user had been listening to a commercial broadcast, audio switch 42 would return the listener to that broadcast by disabling the comm audio out 40 while simultaneously enabling the broadcast audio out 46.

There is one condition whereby CPU 26 does not maintain receiver 22 on an activity priority frequency. This condition occurs anytime that there is activity on a priority channel of higher priority than the one currently being detected and listened to Consistent with the multiple layers, or nested priority, of the instant invention, CPU 26 will, according to the sampling rates selected for all such higher, but inactive, priority channels, periodically sample these higher priority channels (i.e. by momentarily switching receiver 22 over line 36 to each higher priority frequency) and, if a higher priority signal is present, as reflected by a ‘signal present’ indication on detect output 30, will thereafter maintain the receiver on such higher priority channel while it remains active. And, in turn, the receiver will—if higher priority channels are defined—‘continue-up’ this nested hierarchy of priority to sample channels of yet higher priority. Again, any time a priority channel is sampled while the comm receiver is tuned to another active comm channel, comm audio out 40 will momentarily be gated off to foreclose the appearance of noise and distraction to the listener. It will be observed that, in the event the listener is tuned and listening to a broadcast frequency on receiver 24, the broadcast audio 46 may be maintained by switch 42 at speaker/headset 48 as the periodic priority sampling of receiver 22 generally does not interfere with the essentially independent operation of broadcast receiver 24.

While the preferred embodiments have been described, various alternative embodiments may be utilized within the scope of the invention which is limited only by the following claims and their equivalents.

1. A programmable communications receiver having multi-level priority sampling including a plurality of memory registers each register having a unique memory location and at least two of the memory registers having priority levels associated therewith, said priority levels being ranked whereby one priority level defines a higher priority than another; frequency entry means whereby a user may selectively enter frequencies into each of the memory registers according to the designation and priority level thereof; control means for periodically switching the receiver to each priority frequency programmed into the memory registers in response to a predetermined sequence, the control means including means for maintaining the receiver on any frequency in response to a presence of signal from a detector means; means for detecting the presence of a signal on a frequency to which the control means has switched the receiver whereby the control means maintains the receiver on the switched frequency when the presence of a signal is detected; the predetermined sequence including the continued periodic switching of the receiver to all designated frequencies having priority rankings higher than any frequency to which the control means is maintaining the receiver, the control means maintaining the receiver on any such higher priority frequency in response to a presence of signal from the detector means associated with such higher priority frequency whereby the receiver may monitor activity on multiple level priority frequencies substantially instantaneously switching the receiver to, and maintaining a listening watch on, the highest priority frequency currently in use.

2. The programmable communications receiver of claim 1 including a broadcast receiver; the frequency entry means including means whereby the user may enter a broadcast frequency to which the receiver shall be tuned until otherwise interrupted by the presence of a signal on one of the multiple level priority communications frequency.

3. The programmable communications receiver of claim 2 including scanner means whereby one of the communications and broadcast receivers is automatically switched by the control means sequentially to each frequency defined within a range for frequencies, means for pausing the sequential switching in response to a signal present from the detect means, the control means continuing to periodically switch the communications receiver according to the predetermined sequence whereby the communications or broadcast scanning shall be interrupted by the presence of a signal on one of the multiple priority communications frequency.

4. The programmable communications receiver of claim 3 whereby the periodic switching of the communications receiver according to the predetermined sequence is conducted in the background whereby no interruption to reception of broadcast signals occurs unless the presence of a signal is detected on one of the communications priority frequency.

5. The programmable communications receiver of claim 1 including means for blocking the receiver speaker and headphone audio during each periodic interval where the control means is sampling priority frequencies according to the predetermined sequence by correspondingly momentarily switching the communications receiver to each such frequency whereby such sampling does not significantly distract from reception on another active communications receiver frequency.

6. The programmable communications receiver of claim 2 including display means operatively interconnected to the control means and frequency entry means to allow the user to view the frequency being entered and the identity and priority of the designated frequency and to view which of said designated frequencies is active when the receiver is being maintained on an active priority frequency and to view the priority level thereof.

7. The programmable communications receiver of claim 1 wherein one designated frequency is assigned a high level of priority and wherein the remaining designated channels are assigned an identical lower priority whereby when any of the lower equal level priority channels is active, the control means shall, according to the predetermined sequence, only periodically switch to the single high level frequency to determine whether such frequency is active and to maintain the receiver on said higher priority frequency if it is.

8. The programmable communications receiver of claim 1 in which the predetermined sequence checks for activity on the higher priority channels more frequently than the lower priority channels whereby user attention to activity on the highest such channel is further assured by such more frequent check for activity thereon.
